(19) United States
(12) Patent Application Publication
(10) Pub. No.: US 2005/0247161 A1
(43) Pub. Date: Nov. 10, 2005

(54) Steering wheel for a motor vehicle

(75) Inventors: Bojan Rosman, Stuttgart (DE); Bernd Schwabe, Stuttgart (DE); Thomas Rost, Pforzheim (DE)

Correspondence Address: CROWELL & MORING LLP;INTELLECTUAL PROPERTY GROUP, P.O. BOX 14300, WASHINGTON, DC, 20044-4300, US

(73) Assignee: Dr. Ing. h.c.F. Porsche Aktiengesellschaft

(21) Appl. No.: 11/106,462

(22) Filed: Apr. 15, 2005

(30) Foreign Application Priority Data
May 7, 2004 (DE) 10 2004 022 635.0

(51) Int. Cl. G05G 1/10

(52) U.S. Cl. 74/552

(57) ABSTRACT

A steering wheel is designed for a motor vehicle and contains deformation zones and a ring element with spokes which are connected to the steering shaft via a hub. For optimal steering wheel design, the ring element of the steering wheel is realized as a steel tube rim, and the deformation zones are situated exclusively on the rim. The spokes, made of a light alloy, are cast as integrally adjoining portions of the rim at their respective locations.

This application claims the priority of German application 10 2004 022 635.0, filed May 7, 2004, the disclosure of which is expressly incorporated by reference herein.

### BACKGROUND AND SUMMARY OF THE INVENTION

This invention relates to a steering wheel for a motor vehicle including a ring element with spokes and a hub by which the ring element is connected to a steering shaft.

French document FR 2 353 425 relates to a steering wheel which comprises a steering wheel rim in the form of a metal ring with deformation zones in the spokes to improve motor vehicle passenger safety. The deformation zones are formed through a reduction of the cross sections of both the spokes and the metal ring. The spokes and the metal ring are made of the same material and exhibit the same cross section.

German document DE 37 02 847 C2 describes a steering wheel with a steering wheel core comprised of a rim core and spokes made of a light weight alloy. At ends of the spokes opposite the rim, the steering wheel is secured to a hub with the interposition of a connecting element. The connecting element deforms upon exertion of a predetermined impact load on the steering wheel core.

An object of the invention is to design a motor vehicle steering wheel that offers the driver far reaching protection through deformation zones triggered by an accident-induced impact load. The invention should also thereby improve the ergonomics of the steering wheel.

According to the invention this object can be achieved by having the ring element be a steel tube rim, by locating deformation zones exclusively on the rim, and by making the spokes of a light alloy and casting the spokes as integrally adjoining portions of the rim at respective locations. Further features of the invention are reflected in the claims.

Advantages achieved primarily through the invention are that the deformation zones located exclusively in the rim can be implemented in a simple way, are highly effective against an impact load exerted during an accident, and thereby reduce the risk of injury to the driver. This set of characteristics is realized through the special arrangement and dimensions of the deformation zones on the rim. In this way, the steel tube, which is integrated into the light alloy structure of the spokes, contributes to the increased mass inertia of the steering wheel, resulting in a visibly positive influence on the steering wheel comfort.

An embodiment of the invention is illustrated in the attached drawings, which are discussed in detail below.

### BRIEF DESCRIPTION OF THE DRAWINGS

FIG. 1 is a top view of a steering wheel according to the invention,

FIG. 2 is a section along line II-II of FIG. 1, and

FIG. 3 is a section along line III-III of FIG. 1.

### DETAILED DESCRIPTION OF THE INVENTION

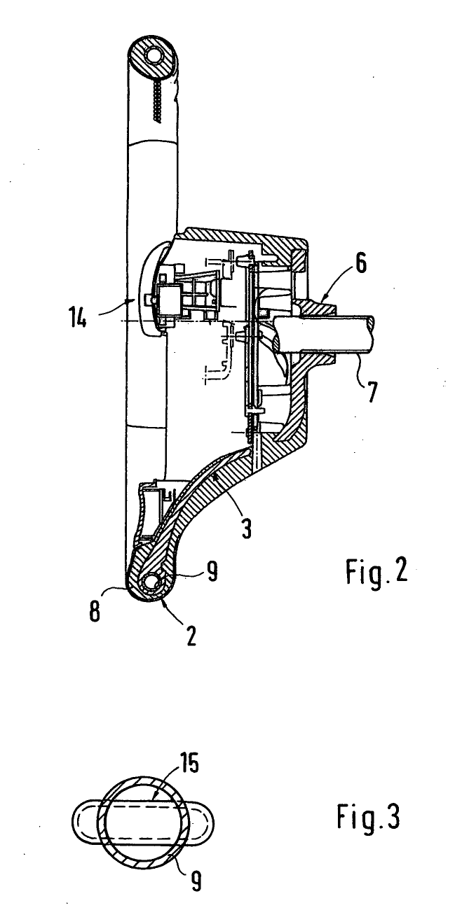

A steering wheel 1 for a motor vehicle of a type not further specified has a ring element 2 and spokes 3, 4 and 5. The spokes 3, 4 and 5 are connected with the steering shaft 7 via a boss 6 as shown in FIG. 2. A foam covering 8 encases the ring element 2 and the spokes 3, 4 and 5.

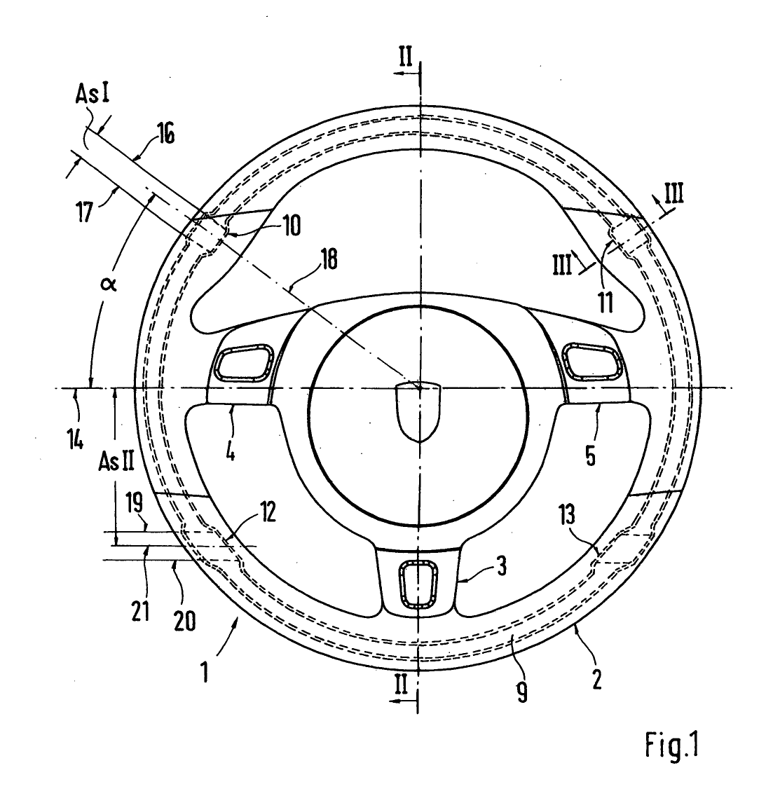

The ring element is a steel tube rim 9. The spokes 3, 4 and 5 are made of a light magnesium alloy and are cast as integrally adjoining portions of the rim 9 at their respective locations, whereby the spoke 3 runs upright, that is vertically, when the steering wheel is in its neutral position. At the same time, the spokes 4 and 5 run horizontally when the steering wheel is in that position. The rim also includes deformation zones 10, 11 and 12, 13, which are activated at a predetermined, and in this example accident-induced, impact load. A first set of deformation zones 10, 11 and a second set of deformation zones 12, 13 are at both ends of a horizontal steering wheel line 14. Each deformation zone, such as the zone 10, for example, is formed by a resistance moment reducing flattening 15 of the rim 9. FIG. 1 shows that the first deformation zones are bordered by the radial lines 16 and 17, which run between the flattened cross section 15 and circular cross section of the rim 9, as shown in FIG. 3. The distance AsI between the lines 16 and 17 of the first set of deformation zones 10 and 11 is 15 and 21 mm, respectively. A radial median line 18 spanning symmetrically between the lines 16 and 17 runs at an angle α, which is oriented from 33° to 37° with respect to the horizontal line 14 of the steering wheel 1.

Finally, each of the second two deformation zones, for example the zone 12, is bordered by lines 19 and 20. The distance AsII between a horizontally running median line 21 spanning between the lines 19 and 20 and the horizontal steering wheel line 14 is between 105 and 110 mm.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A steering wheel for a motor vehicle comprising:
a ring element with spokes, and
a hub by which the ring element is connected to a steering shaft,
wherein the ring element is a steel tube rim,
wherein deformation zones are located exclusively on the rim, and
wherein the spokes are made of a light alloy and are cast as integrally adjoining portions of the rim at respective locations.

2. The steering wheel as claimed in claim 1, wherein a first set of the deformation zones and a second set of the deformation zones are present on both sides of a horizontal steering wheel line.

3. The steering wheel as claimed in claim 2, wherein the deformation zones are formed through flattening a cross section of the rim.

4. The steering wheel as claimed in claim 2, wherein the first set of the deformation zones is bordered by parallel radial lines.

5. The steering wheel as claimed in claim 4, wherein the second set of the deformation zones is bordered by parallel horizontal lines.

6. The steering wheel as claimed in claim 5, wherein distances between the parallel radial lines and between the parallel horizontal lines is between 15 and 21 mm.

7. The steering wheel as claimed in claim 4, wherein a radial medial line spanning between the radial lines of the first set of the deformation zones runs at an angle between 33° and 37° with respect to a horizontal steering wheel line.

8. The steering wheel as claimed in claim 5, wherein the distance from a horizontal median line extending between the horizontal lines of the second set of the deformation zones to a horizontal steering wheel line is between 105 and 110 mm.

9. The steering wheel as claimed in claim 2, wherein the second set of the deformation zones is bordered by parallel horizontal lines.

10. The steering wheel as claimed in claim 5, wherein a radial medial line spanning between the radial lines of the first set of the deformation zones runs at an angle between 33° and 37° with respect to a horizontal steering wheel line.

11. The steering wheel as claimed in claim 6, wherein a radial medial line spanning between the radial lines of the first set of the deformation zones runs at an angle between 33° and 37° with respect to a horizontal steering wheel line.

12. The steering wheel as claimed in claim 6, wherein the distance from a horizontal median line extending between the horizontal lines of the second set of the deformation zones to a horizontal steering wheel line is between 105 and 110 mm.

13. The steering wheel as claimed in claim 9, wherein the distance from a horizontal median line extending between the horizontal lines of the second set of the deformation zones to a horizontal steering wheel line is between 105 and 110 mm.

14. A motor vehicle including a steering wheel comprising:
a ring element with spokes, and
a hub by which the ring element is connected to a steering shaft,
wherein the ring element is a steel tube rim,
wherein deformation zones are located exclusively on the rim, and
wherein the spokes are made of a light alloy and are cast as integrally adjoining portions of the rim at respective locations.

15. The motor vehicle as claimed in claim 14, wherein a first set of the deformation zones and a second set of the deformation zones are present on both sides of a horizontal steering wheel line.

16. The motor vehicle as claimed in claim 15, wherein the deformation zones are formed through flattening a cross section of the rim.

17. The motor vehicle as claimed in claim 15, wherein the first set of the deformation zones is bordered by parallel radial lines.

18. The motor vehicle as claimed in claim 17, wherein the second set of the deformation zones is bordered by parallel horizontal lines.

19. The motor vehicle as claimed in claim 18, wherein distances between the parallel radial lines and between the parallel horizontal lines is between 15 and 21 mm.

20. The motor vehicle as claimed in claim 17, wherein a radial medial line spanning between the radial lines of the first set of the deformation zones runs at an angle between 33° and 37° with respect to a horizontal steering wheel line.

21. The motor vehicle as claimed in claim 18, wherein the distance from a horizontal median line extending between the horizontal lines of the second set of the deformation zones to a horizontal steering wheel line is between 105 and 110 mm.
